(19) United States
(12) Patent Application Publication
(10) Pub. No.: US 2026/0039675 A1
(43) Pub. Date: Feb. 5, 2026

(54) DATA-AWARE ANOMALY DETECTION

(71) Applicant: Rubrik, Inc., Palo Alto, CA (US)

(72) Inventors: Adi Ashur, Givatayim (IL); Rotem Roizman, Tel Aviv (IL); Gil Dollberg, Tel Aviv (IL); Lior Mizrahi, Herzliya (IL); Eyal Zach, Tel Aviv (IL); Inna Geysman, Tel Aviv (IL)

(21) Appl. No.: 18/794,919

(22) Filed: Aug. 5, 2024

(51) Int. Cl. H04L 9/40

(52) U.S. Cl. CPC H04L 63/1425

(57) ABSTRACT

Methods, systems, and devices for data and resource management are described. A location of a type of data that is present in different locations across multiple data sources of a computing environment may be identified. Logs from multiple data sources may be obtained, where the logs may capture activity information with respective data sources. The logs may be converted to a normalized format to obtain normalized logs. Based on determining the location of the type of data, the normalized logs may be associated with the type of data to obtain supplemented activity logs, which may be used to identify anomalous activity associated with the type of data being accessed in the computing environment.

### FIELD OF TECHNOLOGY

The present disclosure relates generally to data and resource management, including techniques for data-aware anomaly detection.

### BACKGROUND

A resource management system (RMS) may be employed to manage data and resources associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The RMS may provide data classification, threat detection, or other types of resource management services for data of, and resources in, the one or more computing systems. Improved resource management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports data-aware anomaly detection in accordance with aspects of the present disclosure.

FIG. 2 shows an example of a subsystem that supports data-aware anomaly detection in accordance with aspects of the present disclosure.

FIG. 3 shows a block diagram of a system that supports data-aware anomaly detection in accordance with aspects of the present disclosure.

FIG. 4 shows a block diagram of a resource manager that supports data-aware anomaly detection in accordance with aspects of the present disclosure.

FIG. 5 shows a diagram of a system including a device that supports data-aware anomaly detection in accordance with aspects of the present disclosure.

FIG. 6 shows a flowchart illustrating methods that support data-aware anomaly detection in accordance with aspects of the present disclosure.

### DETAILED DESCRIPTION

As customer data is stored across a higher quantity of different sources, and as data breaches become more common, the likelihood of a data breach for a customer has also increased, as has the complexity associated with quickly identifying data breaches. Also, the ability to provide anonymous users access to data stored in a data source has increased the complexity associated with identifying data breaches. Additionally, allowing data to be directly accessed from different sources (which may not be under the management or control of the customer), may prevent the customer from itself monitoring for unauthorized access of data from those sources. This increased complexity may result in extended data breaches, which are often correlated with more significant impacts for the customer. Thus, implementations (e.g., methods, systems, apparatuses, techniques, configurations, components) that support quickly identifying data breaches across a computing environment may be desired.

To better (e.g., more quickly, more accurately) identify data breaches across a computing environment, knowledge of locations of sensitive data throughout a computing environment may be combined with logs (e.g., activity log, management logs) generated by different sources in the computing environment to identify anomalous access of customer data. Combining the logs generated by the different sources may include converting the logs into a normalized format (which can then be enriched with the sensitive data knowledge) and performing anomaly detection on the enriched normalized logs.

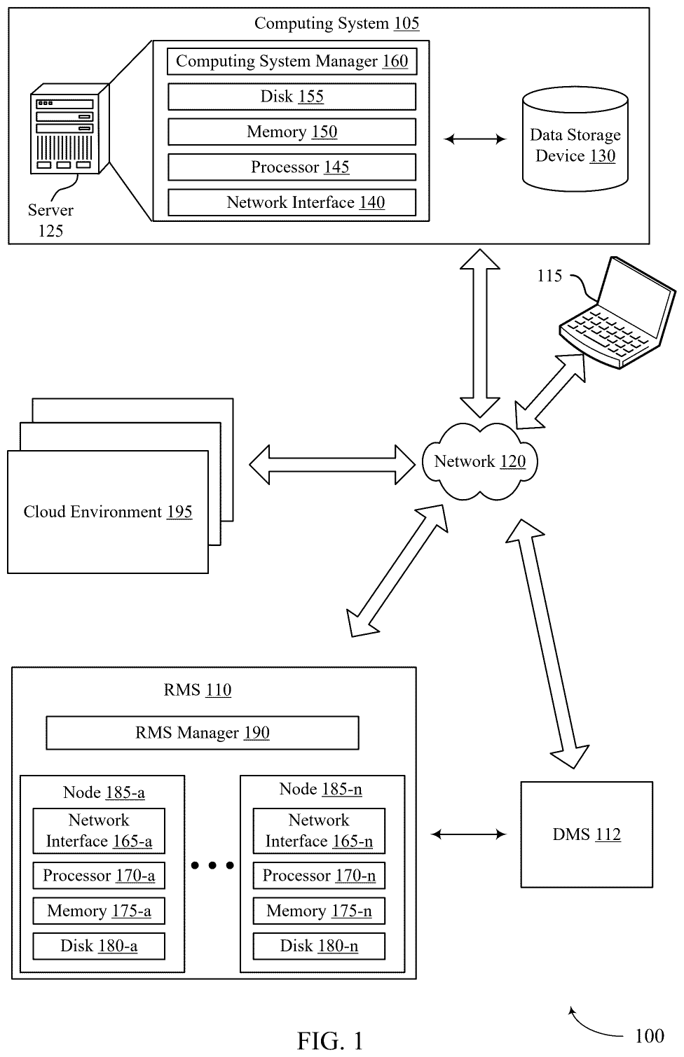

FIG. 1 illustrates an example of a computing environment 100 that supports data-aware anomaly detection in accordance with aspects of the present disclosure. The computing environment 100 may include a computing system 105, a resource management system (RMS) 110, a data management system (DMS) 112, one or more computing devices 115, and one or more cloud environments 195, which may be in communication with one another via a network 120. In some examples, the computing environment includes a computing sub-environment (e.g., that corresponds to a computing environment of a customer). The computing sub-environment may include all the computing resources associated with (e.g., managed by, allocated to, operated by, etc.) a customer—e.g., the computing system 105, the one or more computing devices 115, resources within the cloud environments 195 allocated to the customer, etc.

The computing sub-environment may generate, store, process, modify, or otherwise use associated data. The RMS 110 may provide one or more resource management services for the computing sub-environment. For example, the RMS 110 may provide a threat detection service for the computing sub-environment. The DMS 112 may provide one or more data management services for data associated with the computing sub-environment. For example, the DMS 112 may provide snapshot services data associated with the computing sub-environment. In some examples, the RMS 110 may provide resource management services for computing resources in the computing sub-environment—e.g., for the computing system 105, and customer resources in the one or more cloud environments 195 (e.g., databases, virtual machines, etc.). In some examples, the DMS 112 may provide data management services for computing resources in the computing sub-environment—e.g., for the computing system 105, the one or more computing devices 115, certain resources within the one or more cloud environments 195 (e.g., databases, virtual machines, etc.). In some examples, the RMS 110 may provide resource management services for computing resources in the computing sub-environment that are not serviced by the DMS 112—e.g., for object storage devices that are not (e.g., currently) supported by the DMS 112.

The network 120 may allow the one or more computing devices 115, the computing system 105, and the RMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the RMS 110, or both. For example, a user of the computing device 115 may provide user inputs via the computing device 115, which may result in commands, data, or any combination thereof being communicated via the network 120 to the computing system 105, the RMS 110, or both. Additionally, or alternatively, a computing device 115 may output (e.g., display) data or other information received from the computing system 105, the RMS 110, or both. A user of a computing device 115 may, for example, use the computing device 115 to interact with one or more user interfaces (e.g., graphical user interfaces (GUIs)) to operate or otherwise interact with the computing system 105, the RMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the RMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud environments 195. In some examples, the one or more cloud environments are cloud computing environments, which may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The RMS 110 may provide one or more resource management services for data associated with the computing system 105, the one or more cloud environments 195, or both, and may include RMS manager 190 and any quantity of nodes 185. The RMS manager 190 may manage operation of the RMS 110, including the nodes 185. Though illustrated as a separate entity within the RMS 110, the RMS manager 190 may in some cases be implemented (e.g., as a software application) by one or more of the nodes 185. In some examples, the nodes 185 may be included in a hardware layer of the RMS 110, and the RMS manager 190 may be included in a software layer of the RMS 110. In the example illustrated in FIG. 1, the RMS 110 is separate from the computing system 105 but in communication with the computing system 105 via the network 120. It is to be understood, however, that in some examples at least some aspects of the RMS 110 may be located within computing system 105. For example, one or more servers 125, one or more data storage devices 130, and at least some aspects of the RMS 110 may be implemented within the same cloud environment or within the same data center.

Nodes 185 of the RMS 110 may include respective network interfaces 165, processors 170, memories 175, and disks 180. The network interfaces 165 may enable the nodes 185 to connect to one another, to the network 120, or both. A network interface 165 may include one or more wireless network interfaces, one or more wired network interfaces, or any combination thereof. The processor 170 of a node 185 may execute computer-readable instructions stored in the memory 175 of the node 185 in order to cause the node 185 to perform processes described herein as performed by the node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the nodes 185 may in some cases be referred to as a storage cluster or as a cluster of nodes 185.

In some examples, the RMS 110 may provide a threat detection service (e.g., malware detection, internal or external data breach, intentional or accidental data breach) for data associated with the computing system 105, the one or more cloud environments 195, or both. In some examples, the RMS 110 may analyze logs (which may track activity (e.g., accesses and views of data) within the sources) generated by sources within the computing system 105, sources within the one or more cloud environments 195, or both, to identify anomalous behavior (e.g., excessive file downloads, etc.), which may be indicative of a compromised system. In some examples, the RMS 110 establishes baseline access patterns for the sources, users of the sources, or both, that are used to identify when activity within the source or by a user is anomalous. The RMS 110 may further provide alerts (e.g., to a customer) when anomalous activity has been detected.

The DMS 112 may be implemented similarly (e.g., structurally and/or architecturally) as the RMS 110 and may provide one or more data management services for data associated with the computing system 105, the one or more cloud environments 195, or both. In some examples, the DMS 112 may provide a data classification service, a malware detection service, a data transfer or replication service, backup verification service, or any combination thereof, among other possible data management services for data associated with the computing system 105. For example, the DMS 112 may analyze data included in one or more computing objects of the computing system 105, metadata for one or more computing objects of the computing system 105, or any combination thereof, and based on such analysis, the DMS 112 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 112 may detect whether aspects of the computing system 105 have been impacted by malware (e.g., ransomware). Additionally, or alternatively, the DMS 112 may relocate data or create copies of data based on using one or more snapshots 135 to restore the associated computing object within its original location or at a new location (e.g., a new location within a different computing system 105). Additionally, or alternatively, the DMS 112 may analyze backup data to ensure that the underlying data (e.g., user data or metadata) has not been corrupted. The DMS 112 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105. Although the DMS 112 and the RMS 110 are illustrated in the example of FIG. 1 and described with reference to some examples herein as separate entities, the DMS 112 and RMS 110 may alternatively be combined into a single entity (e.g., functionalities ascribed herein to the DMS 112 may alternatively be included in or performed by the RMS 110, or vice versa).

A customer (e.g., a person, a business, an organization, a resource management provider, etc.) may generate, store, and manage large (e.g., massive) amounts of data—e.g., in the course of business. In some examples, the data may include many different types of data. For example, the data may include sensitive data, such as confidential business information (e.g., financial information, etc.), secret business information (e.g., trade secret information), business payment information, employee payment information, employee personal information, employee health information, and the like. The data may also include non-sensitive (or less sensitive) data, such as publicly available business information and publicly available employee information. Sensitive data may also be further categorized into internally sensitive data and internally non-sensitive (or less sensitive) data. For example, internally sensitive data may include information that is accessible to a limited number of employees (e.g., financial records, working team eyes only document, etc.). And internally non-sensitive (or less sensitive) data may include information that is accessible to all or most employees.

In some examples, the data for a customer may be distributed across a computing environment (e.g., computing system or computing network of computing systems) accessible to the customer, within a single source of a computing system, or across many different sources (e.g., on-premises sources, off-premises sources, cloud sources (such as AWS, Azure, Google, etc.), database sources, etc.) in a computing system or computing network. In either case, the location of sensitive data and non-sensitive data stored in the computing environment may become fragmented over time—e.g., if sensitive data is improperly stored and categorized, if non-sensitive (or less sensitive) data becomes sensitive, if sensitive data becomes non-sensitive (or less sensitive), etc. In such cases, it may require significant effort (and, in some cases, may be infeasible) to identify sensitive data within a computing environment—e.g., so that the appropriate permissions, updated permissions, or both, for accessing the sensitive data can be applied.

Accordingly, the RMS 110 may, using specialized procedures, be configured to scan a computing environment of a customer for sensitive information, and may be further configured to communicate (e.g., to the customer), locations of the sensitive information across the computing environment.

As described herein, data for a customer may be distributed across many different sources within a computing environment. Accordingly, a customer (e.g., employees of a customer) may access data stored in the different sources—e.g., during the course of business. In some examples, the sources may generate and maintain logs (which may also be referred to as activity logs) that monitors access to respectively stored data. For example, the sources may generate an activity log each time a file is accessed. The activity log may include an access time, an activity associated with the access (e.g., read, edit, download, print, screen capture, etc.), a user associated with the access (which in some cases, may be an anonymous user), a role of a user associated with the access, a device associated with the access, a browser associated with the access, a geographic location associated with the access, an IP address associated with the access, whether the access originated from within or outside of the customer's organization, an access duration, an identifier of a key used to access the file, an identifier of a token used to access the file, or any combination thereof.

In some examples, a file of the customer is shared via a unique, though publicly accessible, link. In such cases, the file of the customer may be accessed by users that are unknown to the customer (e.g., users that are external to the organization that are sent or otherwise acquire the link, which may include bad actors). In some examples, the associated source may generate a, activity log that indicates the external user that accessed the file as an anonymous user or may leave the user field empty.

In some examples, the different sources may generate activity logs using different formats (e.g., based on proprietary processes, based on the underlying database application, etc.). Accordingly, activity logs generated by different sources may have different fields for different data, different field names for the same or similar data, and the like.

As customer data is stored across a higher quantity of different sources, and as data breaches (both internal and external and both malicious and accidental) become more common, the likelihood of a data breach for a customer has also increased, as has the complexity associated with quickly identifying data breaches. For example, the ability for different sources to be accessed from across the world, across many different devices, and by both internal and external users, has increased the complexity associated with identifying data breaches. Also, the ability to provide anonymous users access to data stored in a data source (e.g., by sharing a publicly accessible link) has increased the complexity associated with identifying data breaches—e.g., as a customer may not be able to use the identity of the user to identify suspicious behavior. Additionally, allowing data to be directly accessed from different sources (which may not be under the management or control of the customer), may prevent the customer from itself monitoring for unauthorized access of data from those sources. This increased complexity may result in extended data breaches, which are often correlated with more significant impacts for the customer.

Thus, implementations (e.g., methods, systems, apparatuses, techniques, configurations, components) that support quickly identifying data breaches across a computing environment may be desired.

To quickly identify data breaches across a computing environment, knowledge of locations of sensitive data throughout a computing environment may be combined with activity logs generated by different sources in the computing environment to identify anomalous access of customer data. Combining the activity logs generated by the different sources may include converting the activity logs into a normalized format (which can then be enriched with the sensitive data knowledge) and performing anomaly detection on the enriched normalized activity logs.

In some examples, the RMS 110 may determine, for a computing environment that includes multiple data sources, one or more locations of a type of data (e.g., sensitive data) across the multiple data sources. The RMS 110 may also obtain, from the multiple data sources, respective sets of activity logs indicating information regarding the access of respective filesystems (e.g., access of folders and/or files in the file system) within the respective multiple data sources. In some examples, a set of activity logs received from one data source of the multiple data sources may be formatted differently than a set of activity logs received from another data source. The RMS 110 may convert the activity logs received from the multiple data sources into normalized activity logs that have a normalized format. Based on converting the activity logs to the normalized format, the RMS 110 may further associate the normalized activity logs with the type of data based on the determined locations for the type of data to obtain supplemented activity logs that, in addition to the access information included in the normalized activity logs, provide information regarding the type of data accessed.

The RMS 110 may use the supplemented activity logs to the identify anomalous activity in the computing environment. For example, the RMS 110 may identify anomalous activity based on determining that, within a duration, a threshold quantity of supplemented activity logs indicate that folders, files, or both, associated with the type of data have been accessed.

By combining the knowledge of the location of certain types of data (e.g., sensitive data) within a computing system with logs (e.g., activity or management logs) that are indicative of the activity (e.g., read activity, write activity, folder access activity, administrative activity) of a user within the computing system, anomaly detection techniques that analyze anomalous user activity can be enhanced to detect anomalous behavior of the user more quickly. That is, data-awareness may enable anomaly detection to be performed at a data-type level. For example, rather than determining whether an activity of a user in a computing environment itself is anomalous, a data-aware anomaly detection technique may determine whether an activity of the user with respect to accessing a specific type of data, such as sensitive data, is anomalous—e.g., relative to a standard behavior of the user for accessing that specific type of data.

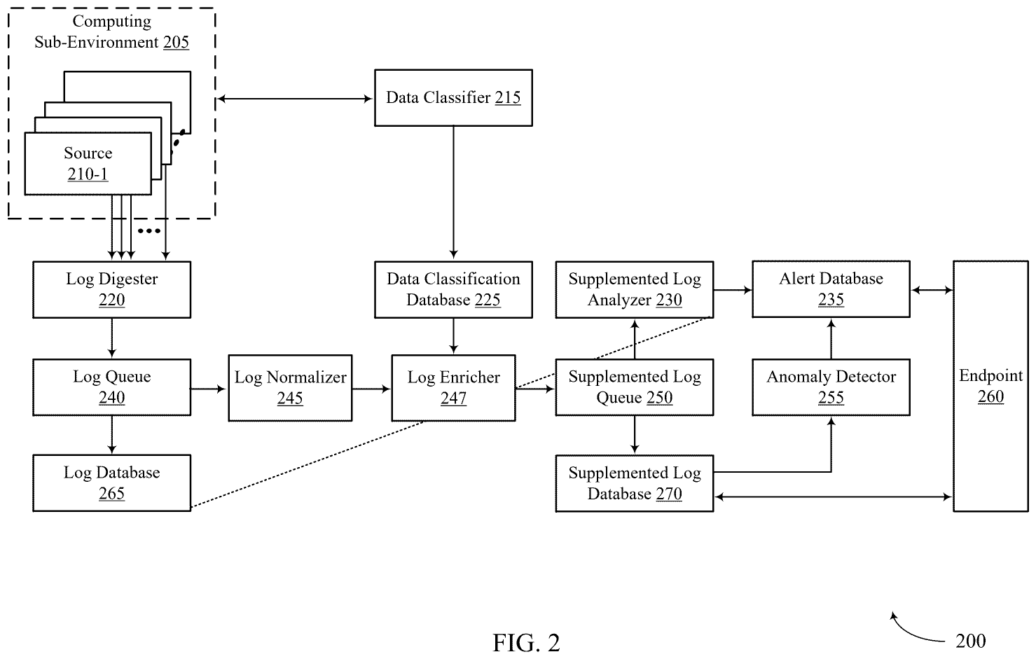

FIG. 2 shows an example of a subsystem that supports data-aware anomaly detection in accordance with examples as disclosed herein.

The subsystem 200 illustrates a resource management architecture as well as an exemplary data flow through the resource management architecture. The subsystem 200 may include the computing sub-environment 205, which may include one or more sources (e.g., the first source 210-1), the data classifier 215, the data classification database 225, the log digester 220, the log queue 240, the log database 265, the log normalizer 245, the log enricher 247, the supplemented log queue 250, the supplemented log analyzer 230, the supplemented log database 270, the anomaly detector 255, the alert database 235, and the endpoint 260. In some examples, the computing sub-environment 205 is an example of a computing sub-environment described herein, including with reference to FIG. 1.

The data classifier 215 and data classification database 225 may be included within a DMS, and RMS, or both. In some examples, a portion of the data classifier 215 in the DMS is used to perform data classification for first computing objects (e.g., on-premises computing objects, particular cloud computing objects, etc.) within the computing sub-environment 205 and a portion of the data classifier 215 in the RMS is used to perform data classification for other second computing objects (e.g., on-premises computing objects, cloud computing objects, etc.) within the computing sub-environment 205. In some examples, all the components in the subsystem 200 apart from the computing sub-environment 205, the data classifier 215, and in some examples, the data classification database 225 may be included within the RMS.

The computing sub-environment 205 may represent the computing resources of a customer and may include one or more sources (including the first source 210-1). The one or more sources may include on-premises equipment, off-premises equipment, cloud equipment, and the like. Data for the customer may be distributed across the one or more sources. The one or more sources may be used to store customer data, to process customer data, to implement virtual machines, and the like. In some examples, sensitive data associated with the customer (e.g., employee data, client data, etc.) may also be distributed across the one or more sources. Additionally, the sensitive data stored at the computing sub-environment 205 may proliferate through the course of business—e.g., as new clients are brought on, as new work for existing clients is performed, as new employees join and leave, etc. Moreover, often, the proliferation of the sensitive data occurs in a decentralized and non-structured way, such that the location of significant amounts of sensitive data may quickly (e.g., in a matter of weeks or months) become obfuscated from the customer.

Sources in the computing environment may generate and maintain activity logs associated with data, a filesystem, or both, within the sources being accessed. In some examples, the activity logs indicate an access time, an activity associated with the access (e.g., read, edit, download, print, screen capture, etc.), a user associated with the access (which in some cases, may be an anonymous user), a role of a user associated with the access, a device associated with the access, a browser associated with the access, a geographic location associated with the access, an IP address associated with the access, whether the access originated from within or outside of the customer's organization, an access duration, an identifier of a key used to access the file, an identifier of a token used to access the file, or any combination thereof. As described herein, the different sources in the computing sub-environment 205 may generate activity logs using different formats, that include different data fields, or both. Additionally, in some examples, the sources (e.g., cloud sources) may be operated by an entity other than the customer. For such sources, the customer may be unable to modify the formats or data included in the activity logs. In some examples, the sources may generate logs at a high rate (e.g., hundreds or thousands of logs per second). In some examples, the logs are stored as individual files. In other examples, multiple (e.g., a threshold quantity of) logs are stored as entries in a single file. In some examples, a log file stores logs in a compressed format that must be decompressed in advance of reading the log file.

In some examples, the sources generate and maintain management logs associated with data, a filesystem, or both, within the sources being accessed. In some examples, the management logs indicate administrative activity, such as changing permissions for a data object (e.g., file, folder, etc.), creating users, updating software, etc.

The data classifier 215 may be configured to analyze the computing sub-environment 205 and to classify the types of data stored across the different sources. In some examples, the data classifier 215 is configured to identify and classify data stored across the sources that is (or likely is) sensitive. In some examples, whether a particular type of data is classified as sensitive may vary from one customer to another. For example, the RMS 110 may receive (e.g., via a user interface, such as user interface provided by the RMS 110 via a network 120 and a computing device 115) one or more inputs that define one or more types of data as sensitive or as non-sensitive. As one such example, the RMS 110 may define some types of data as sensitive by default, and a customer may designate one or more additional types of data as also being sensitive, or a customer may designate one or more of the default types of sensitive data as non-sensitive, or both.

In some examples, the data classifier 215 has access to all (or most) of the data stored in the computing environment. The data classifier 215 may identify the locations of the data classified as sensitive and may store the identified locations in the data classification database 225. In some examples, the data classifier identifies the location of data within the computing environment by analyzing data stored in the computing environment. For example, the data classifier may analyze the contents of a file for particular numeric formats (e.g., indicative of social security numbers), particular phrases (e.g., associated with medical information), and the like. In some examples, the data classifier may memorialize the identified locations using file system identifiers (e.g., folder or file paths), memory-level identifiers (e.g., sector or block identifiers), or any combination thereof.

The data classification database 225 may store the locations of data that has been classified by the data classifier 215 (e.g., as sensitive).

The log digester 220 may be configured to obtain the activity logs and, in some examples, the management logs from the one or more sources. In some examples, the log digester 220 is implemented as multiple log digesters, where each log digester may be configured to obtain the logs from respective individual sources or groups of sources. In some examples, obtaining the logs includes receiving logs output by the one or more sources via one or more network interfaces of the RMS 110, which may be coupled (e.g., via a network) with one or more network interfaces of the one or more sources. Additionally or alternatively, the RMS may obtain the logs via one or more application programming interfaces (e.g., APIs) associated with the one or more sources. The log digester 220 may be further configured to send the obtained logs to the log queue 240.

The log queue 240 may be configured to temporarily store (e.g., in computer memory of the RMS 110) the logs received from the log digester 220. In some examples, the log queue 240 may be configured to temporarily store the logs until the logs may be transferred to the log normalizer 245 for processing. The log queue 240 may also be configured to send the logs to the log database 265 for storage.

The log database 265 may be configured to obtain, from the log queue 240, the logs obtained by the log digester 220. The log database 265 may be configured to provide long-term (e.g., weeks, months, years, or indefinite) storage for the logs (which may also be referred to as “raw logs”). In some examples, the logs stored in the log database 265 are used to support post-breach forensic analysis of the logs associated with the breach, which may be used to improve one or more procedures executed at the anomaly detector 255 for identifying anomalies using the supplemented log database.

The log normalizer 245 may be configured to retrieve and process the logs from the log queue 240. The log normalizer 245 may be configured to normalize the logs received from the different sources into a normalized format to obtain “normalized logs.” In some examples, the logs are received as individual computing files and normalizing the logs includes modifying the data within the individual files to be in the normalized format. In some examples, the logs are received as individual files and normalizing the logs includes transferring data within the individual files into different computing files that are configured in accordance with the normalized format. In some examples, sets of logs are received in individual files. In such cases, normalizing the logs may include modifying the data within the individual files to be in the normalized format or transferring the data within the individual files to different files that are configured in accordance with the normalized format.

In some examples, the normalized format includes one or more of the following fields: an actor field, a request field, an action field, a resource field, a time field, and an outcome field. A log formatted in accordance with the normalized format may indicate that an actor, with a request, did an action (e.g., read, write, etc.) on resources (e.g., identified using a data object ID, such as an Azure storage bucket) at a time, resulting in an outcome (e.g., succeeded, failed, access denied, etc.).

The log enricher 247 may be configured to supplement the logs received from the different sources to indicate a type of data (e.g., sensitive data) associated with the logs (e.g., based on data stored within the data classification database). The log enricher may be configured to obtain the locations of data that has been classified by the data classifier 215 (e.g., as sensitive) from the data classification database 225 via one or more network interfaces (e.g., of the RMS 110, which may be coupled with one or more network interfaces of the data classification database 225) or other communications links. For example, for a first log that is associated with a folder or file being accessed, the log enricher 247 may supplement the first log to obtain a first “supplemented log” that indicates the folder or file being accessed stores sensitive data. The log enricher 247 may be further configured to send the supplemented logs to the supplemented log queue 250.

In some examples, a supplemented log includes an additional data field relative to a normalized log. For example, the supplemented log may include a data field (e.g., a sensitive data field) for indicating a type of data (e.g., sensitive data) associated with the access activity indicated in the normalized log. In some examples, enriching a normalized log includes updating a file or entry associated with the normalized log to include an additional data field and setting the data field within the file to indicate of whether the data associated with the normalized log is associated with a specific type of data, such as sensitive data. In some examples, all normalized logs are updated to include the additional data field regardless of whether a normalized log is associated with sensitive data—e.g., if the normalized log is not associated with sensitive data the data field may be set to indicate the same.

In some examples, the log enricher 247 may use the data classification data to infer or enhance an identity of a user associated with a normalized log (e.g., if the identity of the user associated with the normalized log is anonymous, generalized (e.g., role-based), or specific to the source). For example, for normalized logs associated with an Azure system, user identity information extracted from aspects of the computing sub-environment 205 managed by a customer may be used to associate identity information managed by Azure (e.g., an Azure user ID) with identity information for a user that is managed by the customer (e.g., an email address, username, or other metadata). In some examples, management logs may be used in combination with activity logs to infer an identity of the user associated with the normalized log—e.g., administrative behavior for data that concurrently or subsequently being accessed may narrow the pool of users potentially accessing the data.

The supplemented log queue 250 may be configured to temporarily store the logs received from the log enricher 247. In some examples, the supplemented log queue 250 may be configured to temporarily store the supplemented logs until the supplemented logs may be transferred to the supplemented log database 270, the supplemented log analyzer 230, or both, for processing. The supplemented log queue 250 may also be configured to send the supplemented logs to the supplemented log database 270 for storage.

The supplemented log analyzer 230 may analyze the supplemented logs received from the supplemented log queue 250. For example, the supplemented log analyzer 230 may determine a time since the last access of the currently accessed data associated with the supplemented log, among other analysis which may be performed by the supplemented log analyzer 230. In some examples, the supplemented log analyzer 230 is configured to identify supplemented logs for which the time between accesses exceeds a time threshold (e.g., months or years). The supplemented log analyzer 230 may be further configured to send a result of the supplemented log analysis to the alert database 235.

The supplemented log database 270 may be configured to obtain supplemented logs from the supplemented log queue 250. The supplemented log database 270 may be configured to provide long-term (e.g., weeks, months, or years) storage of the supplemented logs. The supplemented log database 270 may be further configured to provide the stored supplemented logs to the anomaly detector 255.

The anomaly detector 255 may be configured to retrieve (e.g., periodically) the supplemented logs from the supplemented log database 270 (e.g., via one or more network interfaces, communications links, or any combination thereof). The anomaly detector 255 may be further configured to analyze the supplemented log database for indications (e.g., patterns) of anomalous behavior based on the data classification information included for the supplemented logs. For example, the anomaly detector 255 may identify anomalous activity if a quantity of supplemented logs indicating the access of sensitive data are received within a threshold duration of one another. In some examples, the anomaly detector 255 may identify anomalous activity if a quantity of supplemented logs indicating the access of folders storing sensitive data are accessed within a threshold duration of one another (regardless of whether the sensitive data is itself accessed)—which may be a post-compromise, but pre-breach indicator of malicious activity. The anomaly detector 255 may be further configured to send indications of anomalous activity to the alert database 235.

In some examples, the anomaly detector 255 may generate baselines for users associated with accessing data within the computing environment. For examples, the anomaly detector 255 may establish a baseline that indicates an average quantity of folders and/or files accessed by a user within a time period (e.g., an hour, a day, etc.), an average quantity of folders and/or files containing sensitive data accessed by the user within a time period, etc. In some examples, the anomaly detector 255 identifies anomalous behavior if the activity of the user deviates from an activity baseline for the user by a threshold amount. In some examples, the log enricher 247 may use the user baselines established by the anomaly detector 255 to infer user identities from received normalized logs—e.g., by matching a set of logs (e.g., associated with an anonymous or role-based user) with an activity baseline for a user. By normalizing and enriching the numerous logs generated by the one or more sources in real-time (or near real-time), the anomaly detector 255 may maintain up-to-date activity baselines for users. Additionally, the anomaly detector 255 may autonomously and quickly (e.g., within seconds, minutes, or hours) detect anomalous behavior for a user at a data-level—e.g., based on the user accessing specific types of data, such as sensitive data, and even if, at a macro-level, the behavior of the user would not be detected as anomalous (e.g., if an attacker maintains the compromised file accesses below a threshold).

In some examples, the anomaly detector 255 includes one or more workers, which individually analyze the supplemented logs in the supplemented log database 270 for particular anomalistic activity. As described herein, post-breach analysis of the log database 265 may be used to enhance existing anomaly detection procedures, to generate new existing anomaly detection procedures, or both.

The alert database 235 may be configured to store results of the supplemented log analysis performed by the supplemented log analyzer 230 and results of the anomaly detection performed by the anomaly detector 255. The alert database 235 may be further configured to send alerts to the endpoint 260. The endpoint 260 may be a user interface or other entity configured to output indications (e.g., visual indications, audio indications, or any combination thereof) of alerts to a user. In some examples, the alert database 235 is configured to send alerts having a threshold priority (e.g., a high priority) to the endpoint 260. In some examples, the alert database 235 may send having less than the threshold priority in response to a request from the endpoint 260 for lower-priority alerts.

In some examples, the supplemented log database 270 may receive a request from the endpoint 260 for the supplemented logs associated with an alert obtained at the endpoint 260 from the alert database 235. In such cases, the supplemented log database 270 may be configured to send the associated supplemented logs to the endpoint 260.

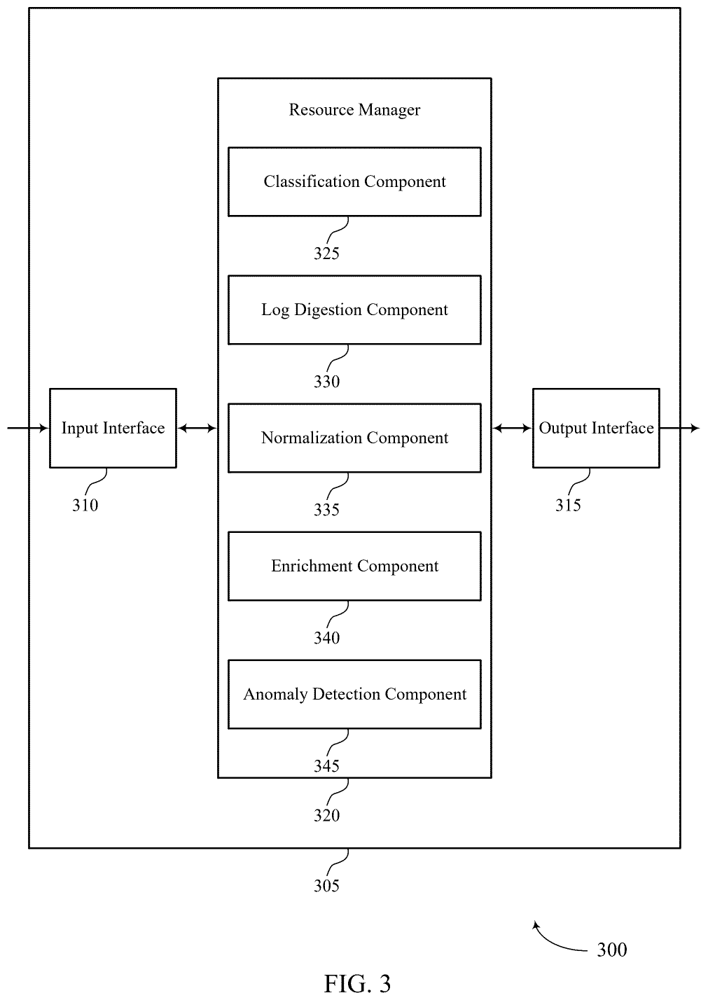

FIG. 3 shows a block diagram 300 of a system 305 that supports data-aware anomaly detection in accordance with aspects of the present disclosure. In some examples, the system 305 may be an example of aspects of one or more components described with reference to FIG. 1, such as an RMS 110. The system 305 may include an input interface 310, an output interface 315, and a resource manager 320. The system 305 may also include one or more processors. Each of these components may be in communication with one another (e.g., via one or more buses, communications links, communications interfaces, or any combination thereof).

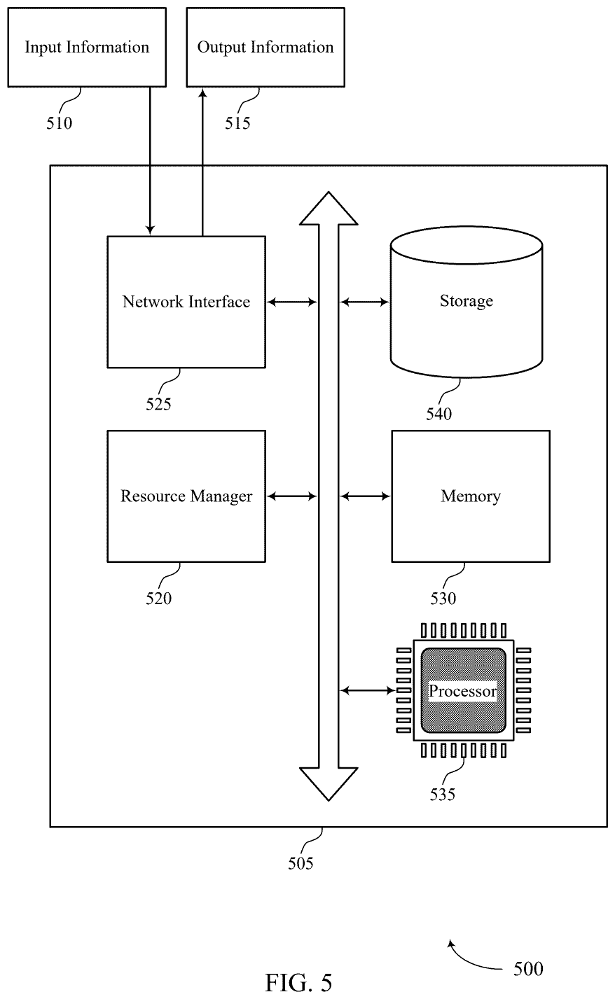

The input interface 310 may manage input signaling for the system 305. For example, the input interface 310 may receive input signaling (e.g., messages, packets, data, instructions, commands, or any other form of encoded information) from other systems or devices. The input interface 310 may send signaling corresponding to (e.g., representative of or otherwise based on) such input signaling to other components of the system 305 for processing. For example, the input interface 310 may transmit such corresponding signaling to the resource manager 320 to support data-aware anomaly detection. In some cases, the input interface 310 may be a component of a network interface 525 as described with reference to FIG. 5.

The output interface 315 may manage output signaling for the system 305. For example, the output interface 315 may receive signaling from other components of the system 305, such as the resource manager 320, and may transmit such output signaling corresponding to (e.g., representative of or otherwise based on) such signaling to other systems or devices. In some cases, the output interface 315 may be a component of a network interface 525 as described with reference to FIG. 5.

For example, the resource manager 320 may include a classification component 325, a log digestion component 330, a normalization component 335, an enrichment component 340, an anomaly detection component 345, or any combination thereof. In some examples, the resource manager 320, or various components thereof, may be configured to perform various operations (e.g., receiving, monitoring, transmitting) using or otherwise in cooperation with the input interface 310, the output interface 315, or both. For example, the resource manager 320 may receive information from the input interface 310, send information to the output interface 315, or be integrated in combination with the input interface 310, the output interface 315, or both to receive information, transmit information, or perform various other operations as described herein.

The classification component 325 may be configured as or otherwise support a means for determining, for a computing environment including a set of multiple data sources, a set of multiple locations of a type of data that is present in different locations across the set of multiple data sources. The log digestion component 330 may be configured as or otherwise support a means for obtaining a first set of multiple activity logs from a first data source of the set of multiple data sources and a second set of multiple activity logs from a second data source of the set of multiple data sources, where the first set of multiple activity logs have a first format and capture activity information associated with the first data source, and where the second set of multiple activity logs have a second format and capture activity information associated with the second data source. The normalization component 335 may be configured as or otherwise support a means for converting, based on obtaining the first set of multiple activity logs and the second set of multiple activity logs, the first set of multiple activity logs and the second set of multiple activity logs to a normalized format to obtain a set of multiple normalized activity logs. The enrichment component 340 may be configured as or otherwise support a means for associating, based on the set of multiple locations determined for the type of data, the set of multiple normalized activity logs with the type of data to obtain a set of multiple supplemented activity logs. The anomaly detection component 345 may be configured as or otherwise support a means for identifying, based on the set of multiple supplemented activity logs, anomalous activity in the computing environment, the anomalous activity associated with the type of data being accessed in the first data source, the type of data being accessed in the second data source, or both.

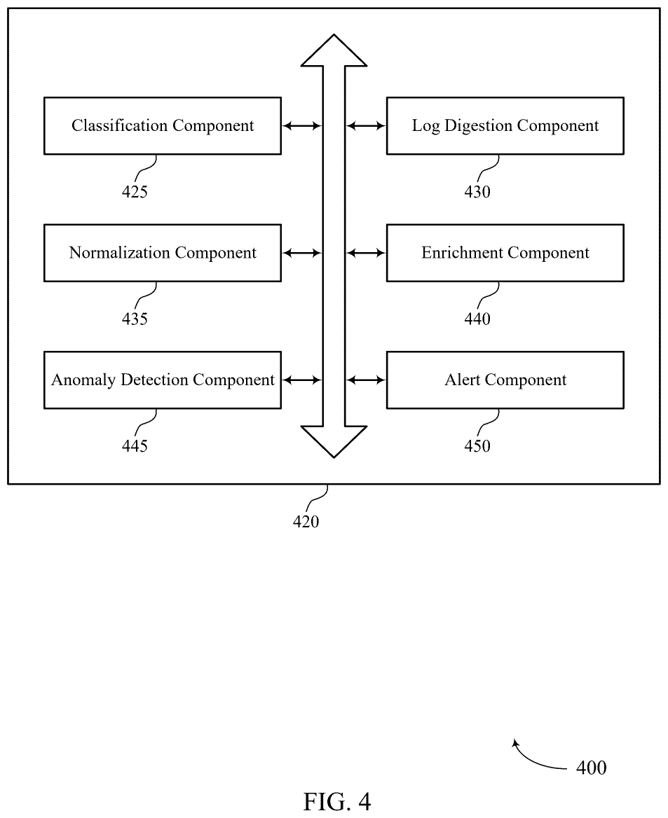

FIG. 4 shows a block diagram 400 of a resource manager 420 that supports data-aware anomaly detection in accordance with aspects of the present disclosure. The resource manager 420 may be an example of aspects of a resource manager or a resource manager 320, or both, as described herein. The resource manager 420, or various components thereof, may be an example of means for performing various aspects of data-aware anomaly detection as described herein. For example, the resource manager 420 may include a classification component 425, a log digestion component 430, a normalization component 435, an enrichment component 440, an anomaly detection component 445, an alert component 450, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The classification component 425 may be configured as or otherwise support a means for determining, for a computing environment including a set of multiple data sources, a set of multiple locations of a type of data that is present in different locations across the set of multiple data sources. The log digestion component 430 may be configured as or otherwise support a means for obtaining a first set of multiple activity logs from a first data source of the set of multiple data sources and a second set of multiple activity logs from a second data source of the set of multiple data sources, where the first set of multiple activity logs have a first format and capture activity information associated with the first data source, and where the second set of multiple activity logs have a second format and capture activity information associated with the second data source. The normalization component 435 may be configured as or otherwise support a means for converting, based on obtaining the first set of multiple activity logs and the second set of multiple activity logs, the first set of multiple activity logs and the second set of multiple activity logs to a normalized format to obtain a set of multiple normalized activity logs. The enrichment component 440 may be configured as or otherwise support a means for associating, based on the set of multiple locations determined for the type of data, the set of multiple normalized activity logs with the type of data to obtain a set of multiple supplemented activity logs. The anomaly detection component 445 may be configured as or otherwise support a means for identifying, based on the set of multiple supplemented activity logs, anomalous activity in the computing environment, the anomalous activity associated with the type of data being accessed in the first data source, the type of data being accessed in the second data source, or both.

In some examples, the type of data is sensitive data, and the plurality of locations are locations of sensitive data across the plurality of data sources.

In some examples, the enrichment component 440 may be configured as or otherwise support a means for storing, after associating the set of multiple normalized activity logs with the type of data, the set of multiple supplemented activity logs in a database, where identifying the anomalous activity includes periodically performing one or more procedures for analyzing the stored set of multiple supplemented activity logs for one or more types of anomalous activity.

In some examples, the anomaly detection component 445 may be configured as or otherwise support a means for storing, based on periodically performing the one or more procedures, indications of the identified anomalous activity in a second database. In some examples, the alert component 450 may be configured as or otherwise support a means for indicating via a user interface, based on storing the indications of the identified anomalous activity, an occurrence of the identified anomalous activity.

In some examples, the alert component 450 may be configured as or otherwise support a means for receiving, based on indicating the occurrence of the identified anomalous activity, a request for supplemented activity logs of the set of multiple supplemented activity logs associated with the anomalous activity. In some examples, the enrichment component 440 may be configured as or otherwise support a means for outputting via the user interface, in response to the request, one or more supplemented activity logs of the set of multiple supplemented activity logs associated with the anomalous activity.

In some examples, the enrichment component 440 may be configured as or otherwise support a means for determining an identity of one or more users associated with one or more respective sets of the set of multiple supplemented activity logs.

In some examples, the enrichment component 440 may be configured as or otherwise support a means for updating, based on determining an identity of a user associated with a set of the set of multiple supplemented activity logs, the set of the set of multiple supplemented activity logs to include an indication of the user.

In some examples, the anomaly detection component 445 may be configured as or otherwise support a means for generating, based on the set of multiple normalized activity logs and the type of data associated with the set of multiple normalized activity logs, respective baselines associated with baseline activity for a set of users within the computing environment.

In some examples, the anomaly detection component 445 may be configured as or otherwise support a means for determining, based on the respective baselines, an identity of one or more users associated with one or more sets of the set of multiple normalized activity logs.

In some examples, the anomalous activity is identified based on deviations in an activity of a user from a baseline activity for the user.

In some examples, the log digestion component 430 may be configured as or otherwise support a means for obtaining a first set of multiple management logs from the first data source and a second set of multiple management logs from the second data source, where a set of management logs of the first set of multiple management logs, a set of management logs of the second set of multiple management logs, or both, indicates an association between a user and a set of activity logs of the first set of multiple activity logs, a set of activity logs of the second set of multiple activity logs, or both.

In some examples, identifying the anomalous activity includes identifying preliminary breach activities based on the set of multiple supplemented activity logs indicating that, within a duration, a threshold quantity of files storing the type of data are included in a first set of multiple directories of the first data source searched by a user, in a second set of multiple directories of the second data source searched by the user, or both.

In some examples, the log digestion component 430 may be configured as or otherwise support a means for storing, in a database, the first set of multiple activity logs obtained from the first data source and the second set of multiple activity logs obtained from the second data source. In some examples, the anomaly detection component 445 may be configured as or otherwise support a means for identifying, after identifying the anomalous activity in the computing environment, an association between characteristics of the first set of multiple activity logs and the second set of multiple activity logs and the identified anomalous activity. In some examples, the anomaly detection component 445 may be configured as or otherwise support a means for updating a procedure for identifying anomalous activity based on the identified association.

FIG. 5 shows a block diagram 500 of a system 505 that supports data-aware anomaly detection in accordance with aspects of the present disclosure. The system 505 may be an example of or include components of a system 305 as described herein. The system 505 may include components for resource management, including components such as a resource manager 520, an input information 510, an output information 515, a network interface 525, at least one memory 530, at least one processor 535, and a storage 540. These components may be in electronic communication or otherwise coupled with each other (e.g., operatively, communicatively, functionally, electronically, electrically; via one or more buses, communications links, communications interfaces, or any combination thereof). Additionally, the components of the system 505 may include corresponding physical components or may be implemented as corresponding virtual components (e.g., components of one or more virtual machines). In some examples, the system 505 may be an example of aspects of one or more components described with reference to FIG. 1, such as an RMS 110.

The network interface 525 may enable the system 505 to exchange information (e.g., input information 510, output information 515, or both) with other systems or devices (not shown). For example, the network interface 525 may enable the system 505 to connect to a network (e.g., a network 120 as described herein). The network interface 525 may include one or more wireless network interfaces, one or more wired network interfaces, or any combination thereof. In some examples, the network interface 525 may be an example of may be an example of aspects of one or more components described with reference to FIG. 1, such as one or more network interfaces 165.

Memory 530 may include RAM, ROM, or both. The memory 530 may store computer-readable, computer-executable software including instructions that, when executed, cause the processor 535 to perform various functions described herein. In some cases, the memory 530 may contain, among other things, a basic input/output system (BIOS), which may control basic hardware or software operation such as the interaction with peripheral components or devices. In some cases, the memory 530 may be an example of aspects of one or more components described with reference to FIG. 1, such as one or more memories 175.

The processor 535 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 535 may be configured to execute computer-readable instructions stored in a memory 530 to perform various functions (e.g., functions or tasks supporting data-aware anomaly detection). Though a single processor 535 is depicted in the example of FIG. 5, it is to be understood that the system 505 may include any quantity of one or more of processors 535 and that a group of processors 535 may collectively perform one or more functions ascribed herein to a processor, such as the processor 535. In some cases, the processor 535 may be an example of aspects of one or more components described with reference to FIG. 1, such as one or more processors 170.

Storage 540 may be configured to store data that is generated, processed, stored, or otherwise used by the system 505. In some cases, the storage 540 may include one or more HDDs, one or more SDDs, or both. In some examples, the storage 540 may be an example of a single database, a distributed database, multiple distributed databases, a data store, a data lake, or an emergency backup database. In some examples, the storage 540 may be an example of one or more components described with reference to FIG. 1, such as one or more network disks 180.

For example, the resource manager 520 may be configured as or otherwise support a means for determining, for a computing environment including a set of multiple data sources, a set of multiple locations of a type of data that is present in different locations across the set of multiple data sources. The resource manager 520 may be configured as or otherwise support a means for obtaining a first set of multiple activity logs from a first data source of the set of multiple data sources and a second set of multiple activity logs from a second data source of the set of multiple data sources, where the first set of multiple activity logs have a first format and capture activity information associated with the first data source, and where the second set of multiple activity logs have a second format and capture activity information associated with the second data source. The resource manager 520 may be configured as or otherwise support a means for converting, based on obtaining the first set of multiple activity logs and the second set of multiple activity logs, the first set of multiple activity logs and the second set of multiple activity logs to a normalized format to obtain a set of multiple normalized activity logs. The resource manager 520 may be configured as or otherwise support a means for associating, based on the set of multiple locations determined for the type of data, the set of multiple normalized activity logs with the type of data to obtain a set of multiple supplemented activity logs. The resource manager 520 may be configured as or otherwise support a means for identifying, basing at least in part on the set of multiple supplemented activity logs, anomalous activity in the computing environment, the anomalous activity associated with the type of data being accessed in the first data source, the type of data being accessed in the second data source, or both.

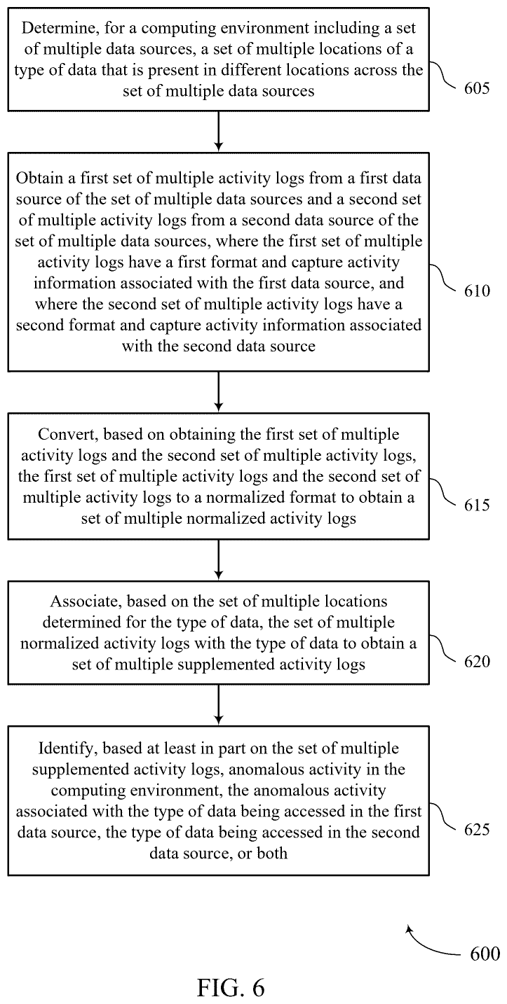

FIG. 6 shows a flowchart illustrating a method 600 that supports data-aware anomaly detection in accordance with aspects of the present disclosure. The operations of the method 600 may be implemented by an RMS or its components as described herein. For example, the operations of the method 600 may be performed by an RMS as described with reference to FIGS. 1 through 5. In some examples, an RMS may execute a set of instructions to control the functional elements of the RMS to perform the described functions. Additionally, or alternatively, the RMS may perform aspects of the described functions using special-purpose hardware.

At 605, the method may include determining, for a computing environment including a set of multiple data sources, a set of multiple locations of a type of data that is present in different locations across the set of multiple data sources. The operations of 605 may be performed in accordance with examples as disclosed herein. In some examples, aspects of the operations of 605 may be performed by a classification component 425 as described with reference to FIG. 4.

At 610, the method may include obtaining a first set of multiple activity logs from a first data source of the set of multiple data sources and a second set of multiple activity logs from a second data source of the set of multiple data sources, where the first set of multiple activity logs have a first format and capture activity information associated with the first data source, and where the second set of multiple activity logs have a second format and capture activity information associated with the second data source. The operations of 610 may be performed in accordance with examples as disclosed herein. In some examples, aspects of the operations of 610 may be performed by a log digestion component 430 as described with reference to FIG. 4.

At 615, the method may include converting, based on obtaining the first set of multiple activity logs and the second set of multiple activity logs, the first set of multiple activity logs and the second set of multiple activity logs to a normalized format to obtain a set of multiple normalized activity logs. The operations of 615 may be performed in accordance with examples as disclosed herein. In some examples, aspects of the operations of 615 may be performed by a normalization component 435 as described with reference to FIG. 4.

At 620, the method may include associating, based on the set of multiple locations determined for the type of data, the set of multiple normalized activity logs with the type of data to obtain a set of multiple supplemented activity logs. The operations of 620 may be performed in accordance with examples as disclosed herein. In some examples, aspects of the operations of 620 may be performed by an enrichment component 440 as described with reference to FIG. 4.

At 625, the method may include identifying, based on the set of multiple supplemented activity logs, anomalous activity in the computing environment, the anomalous activity associated with the type of data being accessed in the first data source, the type of data being accessed in the second data source, or both. The operations of 625 may be performed in accordance with examples as disclosed herein. In some examples, aspects of the operations of 625 may be performed by an anomaly detection component 445 as described with reference to FIG. 4.

A method by a resource management system is described. The method may include determining, for a computing environment including a set of multiple data sources, a set of multiple locations of a type of data that is present in different locations across the set of multiple data sources, obtaining a first set of multiple activity logs from a first data source of the set of multiple data sources and a second set of multiple activity logs from a second data source of the set of multiple data sources, where the first set of multiple activity logs have a first format and capture activity information associated with the first data source, and where the second set of multiple activity logs have a second format and capture activity information associated with the second data source, converting, based on obtaining the first set of multiple activity logs and the second set of multiple activity logs, the first set of multiple activity logs and the second set of multiple activity logs to a normalized format to obtain a set of multiple normalized activity logs, associating, based on the set of multiple locations determined for the type of data, the set of multiple normalized activity logs with the type of data to obtain a set of multiple supplemented activity logs, and identifying, based on the set of multiple supplemented activity logs, anomalous activity in the computing environment, the anomalous activity associated with the type of data being accessed in the first data source, the type of data being accessed in the second data source, or both.

A resource management system is described. The resource management system may include one or more memories storing processor executable code, and one or more processors coupled with the one or more memories. The one or more processors may individually or collectively be operable to execute the code to cause the resource management system to determine, for a computing environment including a set of multiple data sources, a set of multiple locations of a type of data that is present in different locations across the set of multiple data sources, obtain a first set of multiple activity logs from a first data source of the set of multiple data sources and a second set of multiple activity logs from a second data source of the set of multiple data sources, where the first set of multiple activity logs have a first format and capture activity information associated with the first data source, and where the second set of multiple activity logs have a second format and capture activity information associated with the second data source, convert, based on obtaining the first set of multiple activity logs and the second set of multiple activity logs, the first set of multiple activity logs and the second set of multiple activity logs to a normalized format to obtain a set of multiple normalized activity logs, associate, based on the set of multiple locations determined for the type of data, the set of multiple normalized activity logs with the type of data to obtain a set of multiple supplemented activity logs, and identifying, base at least in part on the set of multiple supplemented activity logs, anomalous activity in the computing environment, the anomalous activity associated with the type of data being accessed in the first data source, the type of data being accessed in the second data source, or both.

Another resource management system is described. The resource management system may include means for determining, for a computing environment including a set of multiple data sources, a set of multiple locations of a type of data that is present in different locations across the set of multiple data sources, means for obtaining a first set of multiple activity logs from a first data source of the set of multiple data sources and a second set of multiple activity logs from a second data source of the set of multiple data sources, where the first set of multiple activity logs have a first format and capture activity information associated with the first data source, and where the second set of multiple activity logs have a second format and capture activity information associated with the second data source, means for converting, based on obtaining the first set of multiple activity logs and the second set of multiple activity logs, the first set of multiple activity logs and the second set of multiple activity logs to a normalized format to obtain a set of multiple normalized activity logs, means for associating, based on the set of multiple locations determined for the type of data, the set of multiple normalized activity logs with the type of data to obtain a set of multiple supplemented activity logs, and means for identifying, based on the set of multiple supplemented activity logs, anomalous activity in the computing environment, the anomalous activity associated with the type of data being accessed in the first data source, the type of data being accessed in the second data source, or both.

A non-transitory computer-readable medium storing code is described. The code may include instructions executable by one or more processors to determine, for a computing environment including a set of multiple data sources, a set of multiple locations of a type of data that is present in different locations across the set of multiple data sources, obtain a first set of multiple activity logs from a first data source of the set of multiple data sources and a second set of multiple activity logs from a second data source of the set of multiple data sources, where the first set of multiple activity logs have a first format and capture activity information associated with the first data source, and where the second set of multiple activity logs have a second format and capture activity information associated with the second data source, convert, based on obtaining the first set of multiple activity logs and the second set of multiple activity logs, the first set of multiple activity logs and the second set of multiple activity logs to a normalized format to obtain a set of multiple normalized activity logs, associate, based on the set of multiple locations determined for the type of data, the set of multiple normalized activity logs with the type of data to obtain a set of multiple supplemented activity logs, and identifying, base at least in part on the set of multiple supplemented activity logs, anomalous activity in the computing environment, the anomalous activity associated with the type of data being accessed in the first data source, the type of data being accessed in the second data source, or both.

In some examples of the method, system, and non-transitory computer-readable medium described herein, the type of data may be sensitive data, and the set of multiple locations may be locations of sensitive data across the plurality of data sources.

Some examples of the method, system, and non-transitory computer-readable medium described herein may further include operations, features, means, or instructions for storing, after associating the set of multiple normalized activity logs with the type of data, the set of multiple supplemented activity logs in a database, where identifying the anomalous activity includes periodically performing one or more procedures for analyzing the stored set of multiple supplemented activity logs for one or more types of anomalous activity.

Some examples of the method, system, and non-transitory computer-readable medium described herein may further include operations, features, means, or instructions for storing, based on periodically performing the one or more procedures, indications of the identified anomalous activity in a second database and indicating via a user interface, based on storing the indications of the identified anomalous activity, an occurrence of the identified anomalous activity.

Some examples of the method, system, and non-transitory computer-readable medium described herein may further include operations, features, means, or instructions for receiving, based on indicating the occurrence of the identified anomalous activity, a request for supplemented activity logs of the set of multiple supplemented activity logs associated with the anomalous activity and outputting via the user interface, in response to the request, one or more supplemented activity logs of the set of multiple supplemented activity logs associated with the anomalous activity.

Some examples of the method, system, and non-transitory computer-readable medium described herein may further include operations, features, means, or instructions for determining an identity of one or more users associated with one or more respective sets of the set of multiple supplemented activity logs.

In some examples of the method, system, and non-transitory computer-readable medium described herein, updating, based on determining an identity of a user associated with a set of the set of multiple supplemented activity logs, the set of the set of multiple supplemented activity logs to include an indication of the user.

Some examples of the method, system, and non-transitory computer-readable medium described herein may further include operations, features, means, or instructions for generating, based on the set of multiple normalized activity logs and the type of data associated with the set of multiple normalized activity logs, respective baselines associated with baseline activity for a set of users within the computing environment.

Some examples of the method, system, and non-transitory computer-readable medium described herein may further include operations, features, means, or instructions for determining, based on the respective baselines, an identity of one or more users associated with one or more sets of the set of multiple normalized activity logs.

In some examples of the method, system, and non-transitory computer-readable medium described herein, the anomalous activity may be identified based on deviations in an activity of a user from a baseline activity for the user.

Some examples of the method, system, and non-transitory computer-readable medium described herein may further include operations, features, means, or instructions for obtaining a first set of multiple management logs from the first data source and a second set of multiple management logs from the second data source, where a set of management logs of the first set of multiple management logs, a set of management logs of the second set of multiple management logs, or both, indicates an association between a user and a set of activity logs of the first set of multiple activity logs, a set of activity logs of the second set of multiple activity logs, or both.

In some examples of the method, system, and non-transitory computer-readable medium described herein, operations, features, means, or instructions for identifying the anomalous activity may include operations, features, means, or instructions for identifying preliminary breach activities based on the set of multiple supplemented activity logs indicating that, within a duration, a threshold quantity of files storing the type of data may be included in a first set of multiple directories of the first data source searched by a user, in a second set of multiple directories of the second data source searched by the user, or both.

Some examples of the method, system, and non-transitory computer-readable medium described herein may further include operations, features, means, or instructions for storing, in a database, the first set of multiple activity logs obtained from the first data source and the second set of multiple activity logs obtained from the second data source, identifying, after identifying the anomalous activity in the computing environment, an association between characteristics of the first set of multiple activity logs and the second set of multiple activity logs and the identified anomalous activity, and updating a procedure for identifying anomalous activity based on the identified association.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
determining, for a computing environment comprising a plurality of data sources, a plurality of locations of a type of data that is present in different locations across the plurality of data sources;
obtaining a first plurality of activity logs from a first data source of the plurality of data sources and a second plurality of activity logs from a second data source of the plurality of data sources, wherein the first plurality of activity logs have a first format and capture activity information associated with the first data source, and wherein the second plurality of activity logs have a second format and capture activity information associated with the second data source;
converting, based at least in part on obtaining the first plurality of activity logs and the second plurality of activity logs, the first plurality of activity logs and the second plurality of activity logs to a normalized format to obtain a plurality of normalized activity logs;
associating, based at least in part on the plurality of locations determined for the type of data, the plurality of normalized activity logs with the type of data to obtain a plurality of supplemented activity logs; and
identifying, based at least in part on the plurality of supplemented activity logs, anomalous activity in the computing environment, the anomalous activity associated with the type of data being accessed in the first data source, the type of data being accessed in the second data source, or both.

2. The method of claim 1, wherein the type of data is sensitive data, and wherein the plurality of locations are locations of sensitive data across the plurality of data sources.

3. The method of claim 1, further comprising:
storing, after associating the plurality of normalized activity logs with the type of data, the plurality of supplemented activity logs in a database, wherein identifying the anomalous activity comprises:
periodically performing one or more procedures for analyzing the stored plurality of supplemented activity logs for one or more types of anomalous activity.

4. The method of claim 3, further comprising:
storing, based at least in part on periodically performing the one or more procedures, indications of the identified anomalous activity in a second database; and
indicating via a user interface, based at least in part on storing the indications of the identified anomalous activity, an occurrence of the identified anomalous activity.

5. The method of claim 4, further comprising:
receiving, based at least in part on indicating the occurrence of the identified anomalous activity, a request for supplemented activity logs of the plurality of supplemented activity logs associated with the anomalous activity; and
outputting via the user interface, in response to the request, one or more supplemented activity logs of the plurality of supplemented activity logs associated with the anomalous activity.

6. The method of claim 1, further comprising:
determining an identity of one or more users associated with one or more respective sets of the plurality of supplemented activity logs.

7. The method of claim 6, further comprising:
updating, based at least in part on determining an identity of a user associated with a set of the plurality of supplemented activity logs, the set of the plurality of supplemented activity logs to include an indication of the user.

8. The method of claim 1, further comprising:
generating, based at least in part on the plurality of normalized activity logs and the type of data associated with the plurality of normalized activity logs, respective baselines associated with baseline activity for a set of users within the computing environment.

9. The method of claim 8, further comprising:
determining, based at least in part on the respective baselines, an identity of one or more users associated with one or more sets of the plurality of normalized activity logs.

10. The method of claim 8, wherein the anomalous activity is identified based at least in part on deviations in an activity of a user from a baseline activity for the user.

11. The method of claim 1, further comprising:
obtaining a first plurality of management logs from the first data source and a second plurality of management logs from the second data source, wherein a set of management logs of the first plurality of management logs, a set of management logs of the second plurality of management logs, or both, indicates an association between a user and a set of activity logs of the first plurality of activity logs, a set of activity logs of the second plurality of activity logs, or both.

12. The method of claim 1, wherein identifying the anomalous activity comprises:
identifying preliminary breach activities based at least in part on the plurality of supplemented activity logs indicating that, within a duration, a threshold quantity of files storing the type of data are included in a first plurality of directories of the first data source searched by a user, in a second plurality of directories of the second data source searched by the user, or both.

13. The method of claim 1, further comprising:
storing, in a database, the first plurality of activity logs obtained from the first data source and the second plurality of activity logs obtained from the second data source;
identifying, after identifying the anomalous activity in the computing environment, an association between characteristics of the first plurality of activity logs and the second plurality of activity logs and the identified anomalous activity; and
updating a procedure for identifying anomalous activity based at least in part on the identified association.

14. A resource management system, comprising:
one or more memories; and
one or more processors, wherein the one or more memories store code comprising instructions executable, individually or collectively, by the one or more processors to cause the resource management system to:
determine, for a computing environment comprising a plurality of data sources, a plurality of locations of a type of data that is present in different locations across the plurality of data sources;
obtain a first plurality of activity logs from a first data source of the plurality of data sources and a second plurality of activity logs from a second data source of the plurality of data sources, wherein the first plurality of activity logs have a first format and capture activity information associated with the first data source, and wherein the second plurality of activity logs have a second format and capture activity information associated with the second data source;
convert, based at least in part on obtaining the first plurality of activity logs and the second plurality of activity logs, the first plurality of activity logs and the second plurality of activity logs to a normalized format to obtain a plurality of normalized activity logs;
associate, based at least in part on the plurality of locations determined for the type of data, the plurality of normalized activity logs with the type of data to obtain a plurality of supplemented activity logs; and
identify, based at least in part on the plurality of supplemented activity logs, anomalous activity in the computing environment, the anomalous activity associated with the type of data being accessed in the first data source, the type of data being accessed in the second data source, or both.

15. The resource management system of claim 14, wherein the type of data is sensitive data, and wherein the plurality of locations are locations of sensitive data across the plurality of data sources.

16. The resource management system of claim 14, wherein the instructions are further executable, individually or collectively, by the one or more processors to cause the resource management system to:
store, after associating the plurality of normalized activity logs with the type of data, the plurality of supplemented activity logs in a database, wherein, to identify the anomalous activity, the instructions are executable, individually or collectively, by the one or more processors to cause the resource management system to:
periodically perform one or more procedures for analyzing the stored plurality of supplemented activity logs for one or more types of anomalous activity.

17. The resource management system of claim 14, wherein the instructions are further executable, individually or collectively, by the one or more processors to cause the resource management system to:
determine an identity of one or more users associated with one or more respective sets of the plurality of supplemented activity logs.

18. The resource management system of claim 14, wherein the instructions are further executable, individually or collectively, by the one or more processors to cause the resource management system to:
generate, based at least in part on the plurality of normalized activity logs and the type of data associated with the plurality of normalized activity logs, respective baselines associated with baseline activity for a set of users within the computing environment.

19. A non-transitory, computer-readable medium storing code that comprises instructions that are executable, individually or collectively, by one or more processors of a resource management system to cause the resource management system to:
determine, for a computing environment comprising a plurality of data sources, a plurality of locations of a type of data that is present in different locations across the plurality of data sources;
obtain a first plurality of activity logs from a first data source of the plurality of data sources and a second plurality of activity logs from a second data source of the plurality of data sources, wherein the first plurality of activity logs have a first format and capture activity information associated with the first data source, and wherein the second plurality of activity logs have a second format and capture activity information associated with the second data source;
convert, based at least in part on obtaining the first plurality of activity logs and the second plurality of activity logs, the first plurality of activity logs and the second plurality of activity logs to a normalized format to obtain a plurality of normalized activity logs;
associate, based at least in part on the plurality of locations determined for the type of data, the plurality of normalized activity logs with the type of data to obtain a plurality of supplemented activity logs; and
identify, based at least in part on the plurality of supplemented activity logs, anomalous activity in the computing environment, the anomalous activity associated with the type of data being accessed in the first data source, the type of data being accessed in the second data source, or both.

20. The non-transitory, computer-readable medium of claim 19, wherein the type of data is sensitive data, and wherein the plurality of locations are locations of sensitive data across the plurality of data sources.
